(19) United States
(12) Patent Application Publication
(10) Pub. No.: US 2015/0289054 A1
(43) Pub. Date: Oct. 8, 2015

(54) MIXER CIRCUIT, AUDIO SIGNAL PROCESSING CIRCUIT, METHOD FOR MIXING AUDIO SIGNALS, AND AUDIO DEVICE FOR A VEHICLE, AUDIO COMPONENT DEVICE AND ELECTRONIC DEVICE USING THE SAME

(71) Applicant: ROHM CO., LTD., Ukyo-ku (JP)

(72) Inventor: Mitsuteru SAKAI, Ukyo-ku (JP)

(21) Appl. No.: 14/678,214

(22) Filed: Apr. 3, 2015

(30) Foreign Application Priority Data
Apr. 7, 2014 (JP) 2014-078825

(51) Int. Cl. H04R 3/00

(52) U.S. Cl. CPC H04R 3/00

(57) ABSTRACT

A mixer circuit includes a first D/A converter configured to convert a first digital audio signal to a first analog audio signal; an inverter configured to invert a polarity of a second digital audio signal to generate a third digital audio signal; a second D/A converter configured to convert the third digital audio signal to a second analog audio signal; and an output stage configured to add the first analog audio signal and the second analog audio signal by changing a polarity of one of the first analog audio signal and the second analog audio signal.

### CROSS-REFERENCE TO RELATED APPLICATIONS

This application is based upon and claims the benefit of priority from Japan Patent Applications No. 2014-078825, filed on Apr. 7, 2014, the entire contents of which are incorporated herein by reference.

### TECHNICAL FIELD

The present disclosure relates to a mixer circuit for mixing two audio signals.

### BACKGROUND

Audio systems with the capability of reproducing audio signals such as CD players, audio amplifiers, car stereo systems, portable radio receivers or portable audio players has become widespread. FIG. 1 is a block diagram of a typical audio system.

An audio system 1001 includes audio sources 1002 and 1003, an analog amplifier 1004, an A/D converter 1010, a DSP (Digital Signal Processor or Digital Sound Processor) 1012, a D/A converter 1014, an analog amplifier 1006, a power amplifier 1008, and an electro-acoustic transducer 1009.

The analog audio source 1002 may be a CD player, a silicon audio player, a mobile phone terminal, or the like and outputs analog audio signals. The analog amplifier 1004 amplifies the analog audio signals from the analog audio source 1002 to match the amplified signal to the input range of the A/D converter 1010 at the succeeding stage. The digital audio source 1003 may be a CD player, a silicon audio player, a mobile phone terminal, or the like and outputs digital audio signals. The DSP 1012 receives a digital audio signal from the A/D converter 1010 or a digital audio signal from the digital audio source 1003 at the preceding stage to perform a predetermined digital signal processing. The signal processing performed by the DSP 1012 may include, for example, equalizing, bass boosting, treble boosting, stereo-monaural switching, digital volume control, etc.

The D/A converter 1014 converts the digital audio signal processed by the DSP 1012 to an analog audio signal. The analog amplifier 1006 may be, for example, an analog volume circuit, and amplifies an output signal of the D/A converter 1014 by a gain according to a volume value. The power amplifier 1008 amplifies an output of the analog amplifier 1006 and drives a speaker or a headphone, i.e., the electro-acoustic transducer 1009.

The audio system 1001 may be used to mix and play a plurality of different audio sources 1002 and 1003. For example, in an audio system for a vehicle, while an audio signal from a main audio source (e.g., a CD player or a television) is being played, an audio guidance from a navigation device may be mixed with the audio signal to be played together.

FIGS. 2A to 2C are block diagrams of mixer circuits in the related art.

A mixer circuit 1200a of FIG. 2A mixes two audio signals D1 and D2 by a digital adder 1202 in the digital domain, and converts the mixed audio signal D3 to an analog audio signal by the D/A converter 1014.

A mixer circuit 1200b of FIG. 2B mixes two audio signals in the analog domain. The D/A converters 1014_1 and 1014_2 convert digital audio signals D1 and D2 to analog audio signals S1 and S2, respectively. A summing amplifier 1204 adds the two analog audio signals S1 and S2.

A mixer circuit 1200c of FIG. 2C mixes two audio signals in the analog domain. An inverting amplifier 1206 inverts an output signal S2 of the D/A converter 1014_2. A subtracting amplifier 1208 subtracts an output signal S3 of the inverting amplifier 1206 from the audio signal S1.

The mixer circuits of FIGS. 2A to 2C have the following drawbacks. In the audio system shown in FIG. 1, noise components in the power line, the ground line, and the reference voltage line lowers the S/N ratio of the D/A converter 1014. FIGS. 2A to 2C schematically illustrate the waveforms of the signals. It is assumed that a noise component N is generated by the D/A converter(s) in each of FIGS. 2A to 2C.

In the mixer circuit 1200a of FIG. 2A, a noise component N generated by the D/A converter 1014 is included in the output. In the mixer circuits 1200b and 1200c of FIGS. 2B and 2C, respectively, it is assumed that noise components N that are in-phase with each other are introduced into two D/A converters 1014_1 and 1014_2, respectively. In this case, the noise components N that are in-phase with each other are added resulting in a noise component having an amplitude twice the size of the amplitude of the noise component in FIG. 2A.

As shown above, the S/N ratio of the mixer circuits 1200a to 1200c of FIGS. 2A to 2C, respectively, may be improved.

### SUMMARY

The present disclosure provides some embodiments of a mixer circuit capable of reducing a noise component.

According to one embodiment of the present disclosure, provided is a mixer circuit for mixing two audio signals. The mixer circuit includes: a first D/A converter configured to convert a first digital audio signal to a first analog audio signal; an inverter configured to invert a polarity of a second digital audio signal to generate a third digital audio signal; a second D/A converter configured to convert the third digital audio signal to a second analog audio signal; and an output stage configured to add the first analog audio signal and the second analog audio signal by changing a polarity of one of the first analog audio signal and the second analog audio signal.

According to this embodiment, when noise components that are in-phase are introduced into output signals of the first D/A converter and the second D/A converter, respectively, the noise components overlap each other in anti-phase so that they are canceled out, thereby improving the S/N ratio.

The subtracting circuit may be a non-inverting type subtracting circuit.

The subtracting circuit may include: a first operational amplifier; a voltage-dividing circuit comprising a first resistor and a second resistor connected in series, wherein one of the first analog audio signal and the second analog audio signal is received at one end of the voltage-dividing circuit, a reference voltage is received at the other end of the voltage-dividing circuit, and a node between the first resistor and the second resistor is connected to an non-inverting input terminal of the first operational amplifier; a third resistor disposed between an output terminal and an inverting input terminal of the first operational amplifier; a fourth resistor, wherein the other one of the first analog audio signal and the second analog audio signal is received at one terminal of the fourth resistor, and the other terminal of the fourth resistor is connected to the inverting input terminal of the first operational amplifier.

The output stage may include: an inverting amplifier configured to invert one of the first analog audio signal and the second analog audio signal to generate a third analog audio signal; and an adding circuit configured to add the other one of the first analog audio signal and the second analog audio signal and the third analog audio signal.

The adding circuit may be an inverting type adding circuit.

The adding circuit may include: a second operational amplifier, wherein a reference voltage is received at a non-inverting input terminal of the second operational amplifier; a fifth resistor, wherein the other one of the first analog audio signal and the second analog audio signal is received at one terminal of the fifth resistor, and the other terminal of the fifth resistor is connected to an inverting input terminal of the second operational amplifier; a sixth resistor, wherein the third analog audio signal is received at one terminal of the sixth resistor, and the other terminal of the sixth resistor is connected to the inverting input terminal of the second operational amplifier; and a seventh resistor disposed between an output terminal and the inverting input terminal of the second operational amplifier.

The inverting amplifier may include: a third operational amplifier, wherein the reference voltage is received at a non-inverting input terminal of the third operational amplifier; an eighth resistor, wherein the one of the first analog audio signal and the second analog audio signal is received at one terminal of the eighth resistor, and the other terminal of the eighth resistor is connected to an inverting input terminal of the third operational amplifier; and a ninth resistor disposed between an output terminal and the inverting input terminal of the third operational amplifier.

According to another embodiment of the present disclosure, provided is a mixer circuit for mixing a first audio signal and a second audio signal. The mixer circuit includes: a first D/A converter configured to convert a first digital audio signal to a first analog audio signal; a second D/A converter configured to convert a second digital audio signal to a second analog audio signal; and an output stage configured to add the first analog audio signal and the second analog audio signal or subtracting one of the first analog audio signal and the second analog audio signal from the other one of the first analog audio signal and the second analog audio signal. A first noise component is superimposed on the first analog audio signal in the first D/A converter, and a second noise component is superimposed on the second analog audio signal in the second D/A converter, and the second noise component is in phase with the first noise component. The mixer circuit is configured such that (i) the first audio signal and the second audio signal included in an output signal of the output stage have the same polarity, and (ii) the first noise component and the second noise component included in the output signal of the output stage have opposite polarities.

According to this embodiment, a noise component introduced into an output signal of the first D/A converter and a noise component introduced into an output signal of the second D/A converter, which are in-phase, overlap each other in anti-phase so that they are canceled out, thereby improving the S/N ratio.

According to another embodiment of the present disclosure, provided is an audio signal processing circuit. The audio signal processing circuit includes any one of the mixer circuits described above.

The audio signal processing circuit may further include: a digital signal processor configured to perform digital signal processing on each of a plurality of input digital audio signals, and to output the processed plurality of digital audio signals as the first digital audio signal and the second digital audio signal to the mixer circuit.

In some embodiments, the audio signal processing circuit may further include: a first analog volume circuit disposed at a succeeding stage of the first D/A converter of the mixer circuit, the first analog volume circuit is configured to amplify the first analog audio signal by a gain according to a volume setting value; and a second analog volume circuit disposed at a succeeding stage of the second D/A converter of the mixer circuit, the second analog volume circuit is configured to amplify the second analog audio signal by a gain according to the volume setting value.

The audio signal processing circuit may be integrated in a single semiconductor substrate.

As used herein, the phrase “circuit integrated in a single semiconductor substrate” or any variation thereof refers to that all of the circuit elements are formed on a single semiconductor substrate, and that major circuit elements are integrated within the semiconductor substrate as a single piece, with some resistors, capacitors, and the like used for adjusting circuit constants formed outside the semiconductor substrate.

By implementing a circuit as a single IC, the area occupied by the circuit can be reduced and characteristics of circuit elements can be maintained consistent.

According to another embodiment of the present disclosure, provided is an audio device for a vehicle. The audio device for a vehicle includes any one of the audio signal processing circuits described above.

According to another embodiment of the present disclosure, provided is an audio component device. The audio component device may include any one of the audio signal processing circuits described above.

According to another embodiment of the present disclosure, provided is an electronic device. The electronic device may include any one of the audio signal processing circuits described above.

It is to be understood that any combinations of the elements described above, as well as the elements and expressions interchangeably used for describing methods, devices, systems, etc., are also construed as aspects of the present disclosure.

### BRIEF DESCRIPTION OF THE DRAWINGS

FIG. 1 is a block diagram of a typical audio system;

FIGS. 2A to 2C are block diagrams of mixer circuits in the related art;

FIG. 3 is a block diagram of a mixer circuit according to a first embodiment of the present disclosure;

FIG. 4 is a diagram illustrating operation waveforms of the mixer circuit of FIG. 3;

FIG. 5 is a block diagram of a mixer circuit according to a second embodiment of the present disclosure;

FIG. 6 is a diagram illustrating operation waveforms of the mixer circuit of FIG. 5;

FIG. 7 is a block diagram of an audio system including a mixer circuit;

FIG. 8 is a perspective view of an audio device for a vehicle; and

FIGS. 9A to 9C are diagrams illustrating appearances of electronic devices and audio component devices.

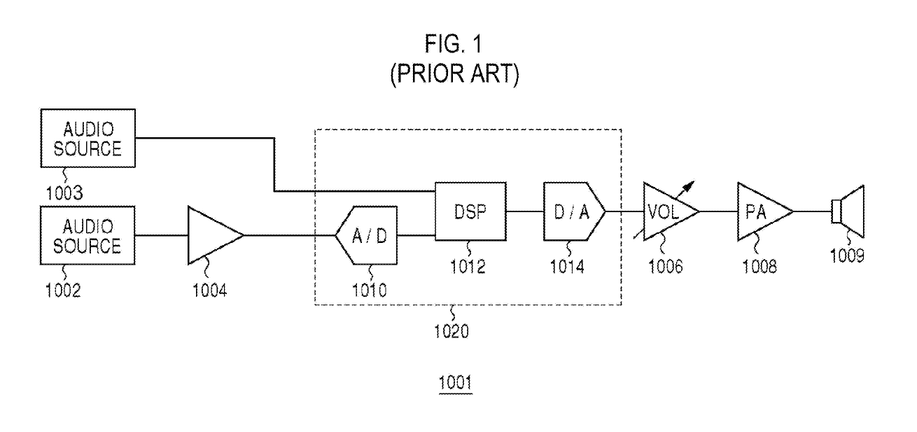

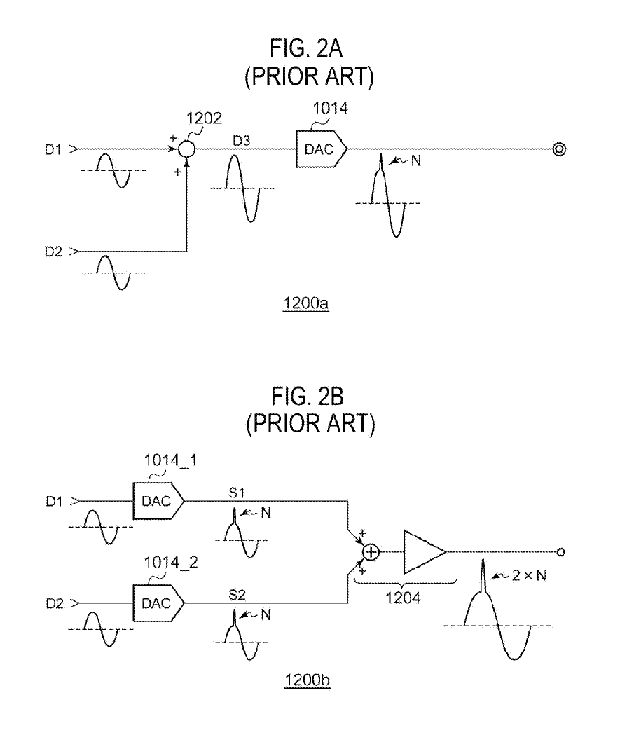

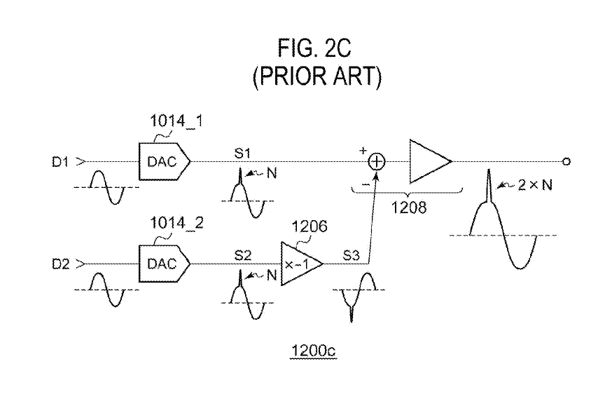

### DETAILED DESCRIPTION

Various embodiments of the present disclosure will be described below in detail with reference to the accompanying drawings. Throughout the drawings, the same or similar elements, members, and processes are denoted by the same reference numerals and redundant descriptions thereof may be omitted. The disclosed embodiments are provided for the purpose of illustration, not limitation, of the present disclosure, and all features and combinations thereof described in the embodiments cannot be necessarily construed to describe the gist of the present disclosure.

As used herein, the phrase “a member A is connected with a member B” refers to that the member A is physically and directly connected with the member B, and that the member A is connected with the member B via another member that does not electrically affect the connection.

Similarly, the phrase “a member C is interposed between a member A and a member B” refers to that the member A is directly connected with the member C or the member B is directly connected with the member C, and that the members are indirectly connected via another member which does not electrically affect the connection.

### First Embodiment

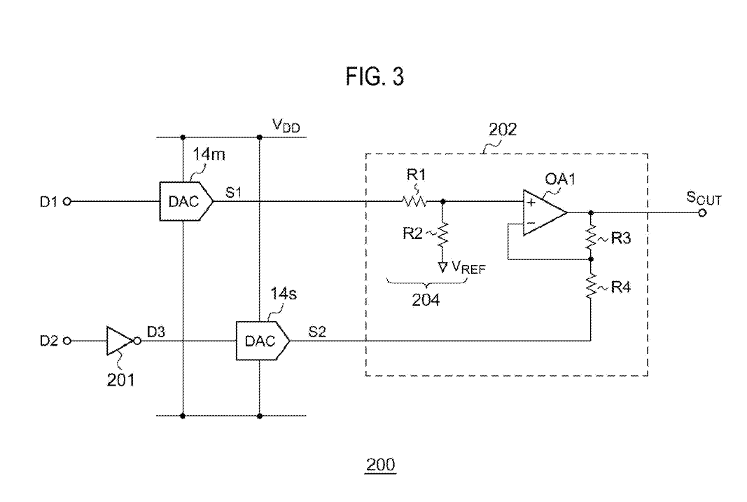

FIG. 3 is a block diagram of a mixer circuit 200 according to a first embodiment of the present disclosure. The mixer circuit 200 mixes two audio signals. The mixer circuit 200 includes a first D/A converter 14m, a second D/A converter 14s, an inverter 201, and an output stage 202.

The first D/A converter 14m converts a first digital audio signal D1 to a first analog audio signal S1. The inverter 201 inverts the polarity of a second digital audio signal D2 to generate a third digital audio signal D3. The second D/A converter 14s converts the third digital audio signal D3 to a second analog audio signal S2.

The output stage 202 adds the first analog audio signal S1 and the second analog audio signal S2 by changing the polarity of one of the first analog audio signal S1 and the second analog audio signal S2. The output stage 202 according to the first embodiment is a subtracting circuit that subtracts one of the first analog audio signal S1 and the second analog audio signal S2 from the other one (subtracts the second analog audio signal S2 from the first analog audio signal S1 in the first embodiment).

The output stage 202 is a non-inverting type subtracting circuit and includes a first operational amplifier OA1 and first to fourth resistors R1 to R4. A voltage-dividing circuit 204 includes the first and second resistors R1 and R2, which are connected in series. At one end of the voltage-dividing circuit 204, one of the first analog audio signal S1 and the second analog audio signal S2 is received (in the first embodiment, the first analog audio signal S1 is received at one end of the voltage-dividing circuit 204). At the other end of the voltage-dividing circuit 204, a reference voltage V_{REF} is received. The node between the first resistor R1 and the second resistor R2 is connected to the non-inverting input terminal (+) of the first operational amplifier OA1. The third resistor R3 is disposed between the output terminal OUT and the inverting input terminal (−) of the first operational amplifier OA1. At one end of the fourth resistor R4, the other one of the first analog audio signal S1 and the second analog audio signal S2 is received (in the first embodiment, the second analog audio signal S2 is received at one end of the fourth resistor R4). The other end of the fourth resistor R4 is connected to the inverting input terminal (−) of the first operational amplifier OA1.

By using the output stage 202, the second analog audio signal S2 is subtracted from the first analog audio signal S1.

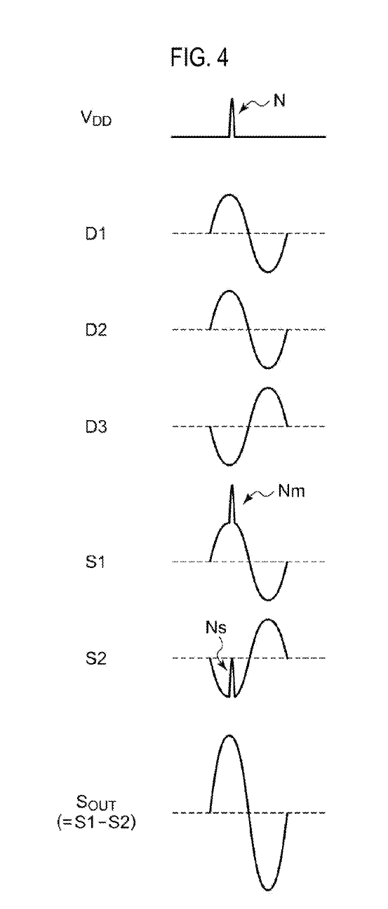

The configuration of the mixer circuit 200 has been described above with reference to FIG. 3. The operation of the mixer circuit 200 will be described in detail below. FIG. 4 is a diagram illustrating operation waveforms of the mixer circuit 200 of FIG. 3. From the top of FIG. 4, the waveforms of a supply voltage V_{DD}, a first digital audio signal D1, a second digital audio signal D2, a third digital audio signal D3, a first analog audio signal S1, a second analog audio signal S2, and an output signal S_{OUT} are shown. For ease of understanding and convenience of illustration, it is assumed that the first digital audio signal D1 and the second digital audio signal D2 have the same waveform.

For example, it is assumed that a noise component N is generated in the supply voltage V_{DD}. When the noise component N is introduced into the first D/A converter 14m and the second D/A converter 14s, noise components Nm and Ns that are in-phase with each other are found in the first analog audio signal S1 and the second analog audio signal S2, respectively, which are output from the first D/A converter 14m and the second D/A converter 14s, respectively.

By using the output stage 202, the second analog audio signal S2 is subtracted from the first analog audio signal S1. As a result, the original first digital audio signal D1 and the second digital audio signal D2 are added in-phase with each other. In this case, the noise components Nm and Ns are added in anti-phase with each other so that they are canceled out. Accordingly, the S/N ratio of the mixer circuit 200 may be improved.

### Second Embodiment

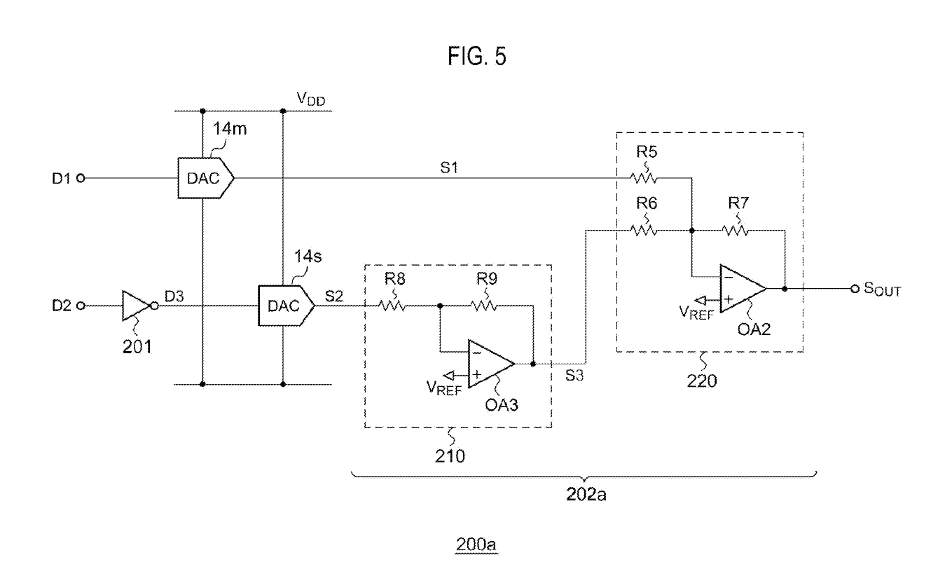

FIG. 5 is a block diagram of a mixer circuit 200a according to a second embodiment of the present disclosure. The mixer circuit 200a mixes two audio signals. The mixer circuit 200a includes a first D/A converter 14m, a second D/A converter 14s, an inverter 201, and an output stage 202a. The first D/A converter 14m, the second D/A converter 14s, and the inverter 201 are identical to those of the first embodiment.

The output stage 202a includes an inverting amplifier 210 and an adding circuit 220. The inverting amplifier 210 inverts one of the first analog audio signal S1 and the second analog audio signal S2 to generate a third analog audio signal S3 (in the second embodiment, the inverting amplifier 210 inverts the second analog audio signal S2). The adding circuit 220 adds the other one of the first analog audio signal S1 and the second analog audio signal S2 and the third analog audio signal S3 (in the second embodiment, the adding circuit 220 adds the first analog audio signal S1 and the third analog audio signal S3).

The adding circuit 220 is an inverting type adding circuit. The adding circuit 220 includes a second operational amplifier OA2 and fifth to seventh resistors R5 to R7. At the non-inverting input terminal (+) of the second operational amplifier OA2, a reference voltage V_{REF} is received. At one end of the fifth resistor R5, the first analog audio signal S1 is received. The other end of the fifth resistor R5 is connected to the inverting input terminal (−) of the second operational amplifier OA2. At one end of the sixth resistor R6, the third analog audio signal S3 is received. The other end of the sixth resistor R6 is connected to the inverting input terminal (−) of the second operational amplifier OA2. The seventh resistor R7 is disposed between the output terminal OUT and the inverting input terminal (−) of the second operational amplifier OA2.

By using the adding circuit 220, the first analog audio signal S1 and the second analog audio signal S2 can be added.

The inverting amplifier 210 includes a third operational amplifier OA3, an eighth resistor R8, and a ninth resistor R9. At the non-inverting input terminal (+) of the third operational amplifier OA3, a reference voltage V_{REF} is received. At one end of the eighth resistor R8, the second analog audio signal S2 is received. The other end of the eighth resistor R8 is connected to the inverting input terminal (−) of the third operational amplifier OA3. The ninth resistor R9 is disposed between the output terminal OUT and the inverting input terminal (−) of the third operational amplifier OA3.

The configuration of the mixer circuit 200a has been described above with reference to FIG. 5. The operation of the mixer circuit 200a will be described in detail below.

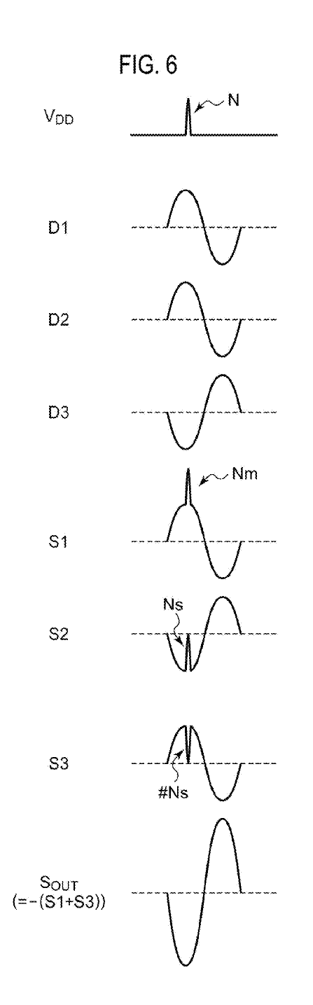

FIG. 6 is a diagram illustrating operation waveforms of the mixer circuit 200a of FIG. 5. From the top of FIG. 6, the waveforms of a supply voltage V_{DD}, a first digital audio signal D1, a second digital audio signal D2, a third digital audio signal D3, a first analog audio signal S1, a second analog audio signal S2, a third analog audio signal S3, and an output signal S_{OUT} are shown. For ease of understanding and convenience of illustration, it is assumed that the first digital audio signal D1 and the second digital audio signal D2 have the same waveform.

It is assumed that a noise component N is generated in the supply voltage V_{DD}. When the noise component N is introduced into the first D/A converter 14m and the second D/A converter 14s, noise components Nm and Ns that are in-phase with each other are found in the first analog audio signal S1 and the second analog audio signal S2, respectively, which are output from the first D/A converter 14m and the second D/A converter 14s, respectively. The noise component #Ns included in the third analog audio signal S3 is in anti-phase with the noise component Nm.

By using the output stage 202a, the first analog audio signal S1 and the third analog audio signal S3 are added, and are inverted and amplified. As a result, the original first digital audio signal D1 and the second digital audio signal D2 are added in-phase with each other. In this case, the noise components Nm and #Ns are added in anti-phase with each other, so that they are canceled out. Accordingly, the S/N ratio of the mixer circuit 200a may be improved.

### (Technical Idea)

The following technical idea that can improve the S/N ratio of a mixer circuit may be derived from the first embodiment and the second embodiment. The mixer circuit 200 includes at least a first D/A converter 14m, a second D/A converter 14s, and an output stage 202. In the first D/A converter 14m, a first noise component Nm is superimposed on a first analog audio signal S1. In the second D/A converter 14s, a second noise component Ns, which is in-phase with the first noise Nm, is superimposed on a second analog audio signal S2. The mixer circuit 200 is configured such that (i) the first audio signal and the second audio signal included in an output signal S_{OUT} of the output stage 202 have the same polarity, and (ii) the first noise component Ns and the second noise component Nm included in the output signal of the output stage 202 have the opposite polarities.

Some embodiments of the present disclosure have been described above. Those skilled in the art would understood that the above embodiments are merely illustrative examples and a variety of modifications are possible by combining the elements and processes therein, and that such modifications also fall within the scope of the present disclosure. Hereinafter, such modifications will be described in detail.

### (First Modification)

In the mixer circuit 200 according to the first embodiment (FIG. 3), the second analog audio signal S2 may be input to the first resistor R1 and the first analog audio signal S1 may be input to the fourth resistor R4. In other words, the output stage 202 may be configured to subtract one of the first analog audio signal S1 and the second analog audio signal S2 from the other one of the first analog audio signal S1 and the second analog audio signal S2 (subtract the first analog audio signal S1 from the second analog audio signal S2 in the first modification).

### (Second Modification)

In the mixer circuit 200a according to the second embodiment (FIG. 5), the inverting amplifier 210 may invert the first analog audio signal S1 to generate the third analog audio signal S3. In this case, the adding circuit 220 may add the second analog audio signal S2 and the third analog audio signal S3.

### (Third Modification)

Although the two audio signals to be mixed have been described as containing audio information in the above-described embodiments, the present disclosure is not limited thereto. In particular, a noise component generated in the D/A converter 14 can be appropriately canceled out even when a single digital audio signal is being played, by enabling the mixing feature, and inputting the digital audio signal to be played on one path while inputting another digital audio signal containing no information, i.e., a silent signal on the other path.

### (Fourth Modification)

Although the above-described embodiments have been described with respect to single-ended audio signals, differential audio signals are also applicable.

### (Application)

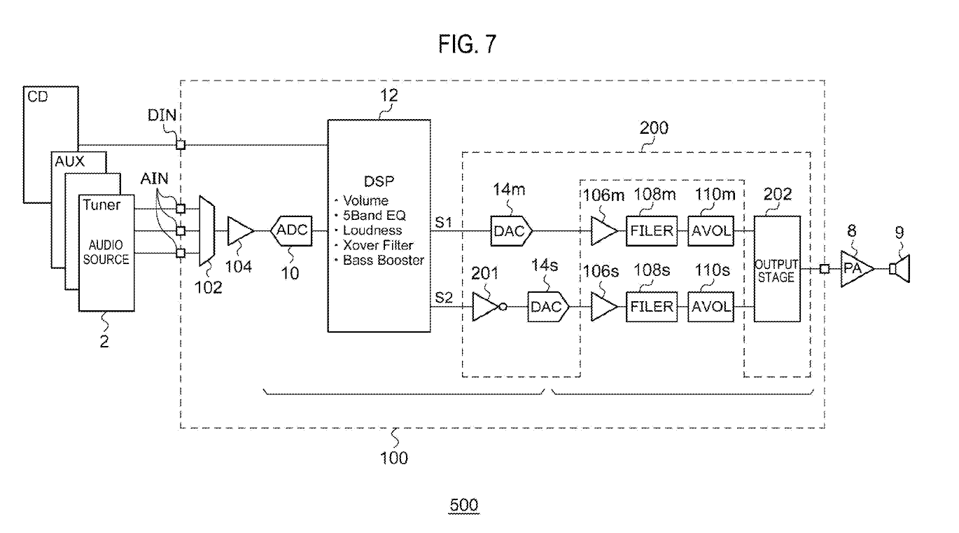

Specific applications of the mixer circuit 200 will be described in detail below. FIG. 7 is a block diagram of an audio system 500 including the mixer circuit 200. In FIG. 7, monaural audio signals have been described for ease of understanding. However, in practice, each of the audio signals may be stereo or multi-channel audio signals. In addition, each of the audio signals may be either single-ended or differential signals. The audio system 500 includes an audio source 2, an audio signal processing circuit 100, a power amplifier 8, and an electro-acoustic transducer 9.

The audio source 2 may be a CD player, a radio tuner, a portable audio device, or the like, and generates analog or digital audio signals.

The audio signal processing circuit 100 receives an audio signal from the audio source 2 to perform a variety of signal processing operations. The power amplifier 8 amplifies an output signal of the audio signal processing circuit 100 and drives the electro-acoustic transducer 9. The electro-acoustic transducer 9 may be a speaker or a headphone.

The audio signal processing circuit 100 is a functional IC (Integrated Circuit) integrated in a single semiconductor substrate, and has a plurality of input terminals. At a digital input terminal DIN, a digital audio signal from a CD player or a DVD player is received. At analog input terminals AIN, analog audio signals are received.

The audio signal processing circuit 100 includes an A/D converter 10, an input selector 102, an amplifier 104, a digital signal processor 12, a mixer circuit 200, amplifiers 106m and 106s, post filters 108m and 108s and analog volume circuits 110m and 110s.

The input selector 102 selects one of a plurality of analog audio signals. The amplifier 104 amplifies an output signal of the input selector 102 to match the input range of the A/D converter 10.

The A/D converter 10 converts the output signal of the input selector 102 to a digital audio signal and outputs the converted signal to the digital signal processor 12. The digital audio signal received at the digital input terminal DIN is directly input to the digital signal processor 12.

The digital signal processor 12 performs a variety of signal processing operations on the input digital audio signal. The signal processing operations of the digital signal processor 12 may include, but not limited to, a digital volume circuit, a multi-band equalizer, a loudness circuit, a bypass filter, a low-pass filter, a bass boost circuit, or the like.

The digital signal processor 12 outputs a subsidiary digital audio signal D2, in addition to a main digital audio signal D1. For example, the main digital audio signal D1 is a sound from a CD player or a television, while the subsidiary digital audio signal D2 is an audio guidance from a navigation device. The configuration and operation of the mixer circuit 200 are identical to those already described above.

In addition, the amplifiers 106m and 106s, the post filters 108m and 10s, and the analog volume circuits 110m and 110s are disposed between the D/A converters 14m and 14s and the output stage 202 of the mixer circuit 200. The amplifier 106m amplifies an output signal of the D/A converter 14m. The post filters 108m and 108s are low-pass filters that filter output signals of the D/A converters 14m and 14s, respectively. The analog volume circuits 110m and 110n amplifies an output signal of the post filters 108m and 108s, respectively, by a gain according to a volume setting value.

The output stage 202 receives output signals of the analog volume circuits 110m and 110s, and adds them together or subtracts one from the other.

In the audio system 500, the volume setting value of the analog volume circuits 110m and 110s, i.e., the gain can be set individually. Although noise can be further reduced with a larger difference between the gains, the volume setting values normally used in practice would be sufficient to obtain a desired effect.

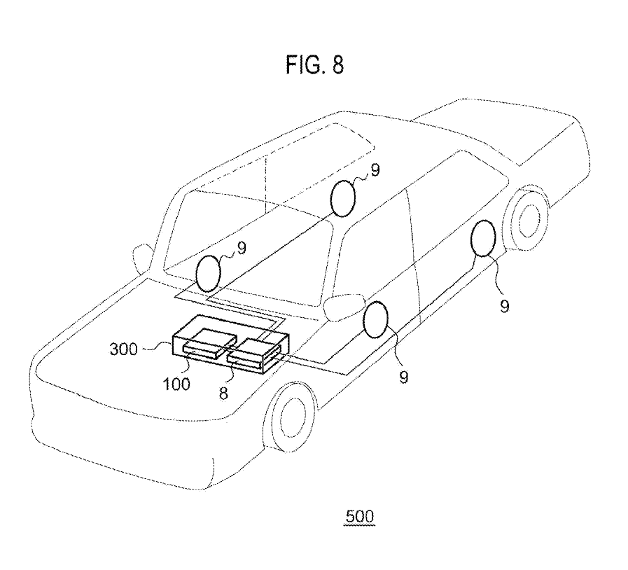

FIG. 8 is a perspective view of an audio device for a vehicle. An audio signal processing circuit 100 and a power amplifier 8 are installed in one housing as an audio head unit 300. Speakers 9 are embedded in front doors, rear doors, etc. The audio head unit 300 receives audio signals from a CD player or a DVD player.

The audio system 500 may be applied to an audio component device of a home audio system, as well as to the audio device for a vehicle. Alternatively, the audio system 500 may be mounted in electronic devices such as a television, a desktop PC, a laptop PC, a tablet PC, a mobile phone terminal, a digital camera, a portable audio player, etc.

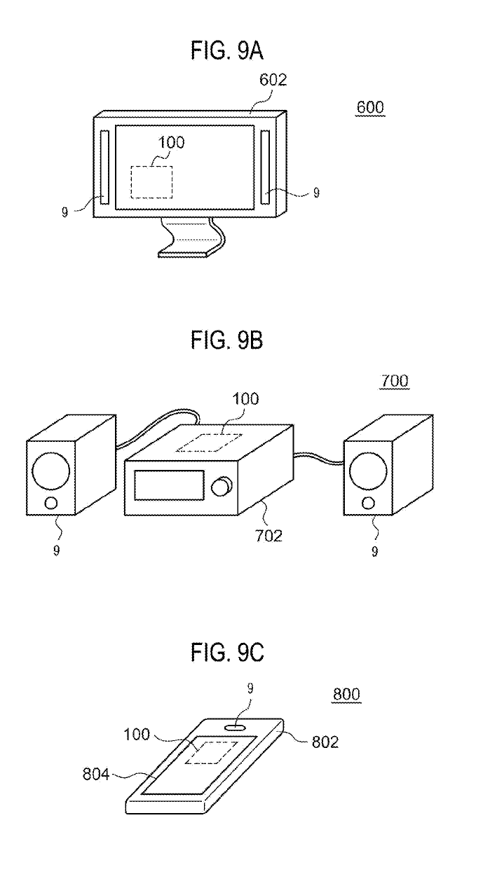

FIGS. 9A to 9C are diagrams illustrating appearances of electronic devices and audio component devices. FIG. 9A illustrates a display device 600 as an example of an electronic device. The display device 600 includes a housing 602 and speakers 9. An audio signal processing circuit 100 is installed in the housing 602 and drives the speakers 9.

FIG. 9B illustrates an audio component 700. The audio component 700 includes a housing 702 and speakers 9. An audio signal processing circuit 100 is installed in the housing 702 and drives the speakers 9.

FIG. 9C illustrates a handheld information terminal 800 as an example of an electronic device. The handheld information terminal 800 may be a mobile phone, a PHS (Personal Handy-phone System), a PDA (Personal Digital Assistant), a tablet PC (Personal Computer), an audio player, etc. The handheld information terminal 800 includes a housing 802, a speaker 9, and a display 804. An audio signal processing circuit 100 is installed in the housing 802 and drives the speaker 9.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A mixer circuit for mixing two audio signals, the mixer circuit comprising:
a first D/A converter configured to convert a first digital audio signal to a first analog audio signal;
an inverter configured to invert a polarity of a second digital audio signal to generate a third digital audio signal;
a second D/A converter configured to convert the third digital audio signal to a second analog audio signal; and
an output stage configured to add the first analog audio signal and the second analog audio signal by changing a polarity of one of the first analog audio signal and the second analog audio signal.

2. The mixer circuit of claim 1, wherein the output stage comprises a subtracting circuit configured to subtract one of the first analog audio signal and the second analog audio signal from the other one.

3. The mixer circuit of claim 2, wherein the subtracting circuit is a non-inverting type subtracting circuit.

4. The mixer circuit of claim 2, wherein the subtracting circuit comprises:
a first operational amplifier;
a voltage-dividing circuit comprising a first resistor and a second resistor connected in series, wherein one of the first analog audio signal and the second analog audio signal is received at one end of the voltage-dividing circuit, a reference voltage is received at the other end of the voltage-dividing circuit, and a node between the first resistor and the second resistor is connected to an non-inverting input terminal of the first operational amplifier;
a third resistor disposed between an output terminal and an inverting input terminal of the first operational amplifier;
a fourth resistor, wherein the other one of the first analog audio signal and the second analog audio signal is received at one terminal of the fourth resistor, and the other terminal of the fourth resistor is connected to the inverting input terminal of the first operational amplifier.

5. The mixer circuit of claim 1, wherein the output stage comprises:
an inverting amplifier configured to invert one of the first analog audio signal and the second analog audio signal to generate a third analog audio signal; and
an adding circuit configured to add the other one of the first analog audio signal and the second analog audio signal and the third analog audio signal.

6. The mixer circuit of claim 5, wherein the adding circuit is an inverting type adding circuit.

7. The mixer circuit of claim 5, wherein the adding circuit comprises:
a second operational amplifier including a non-inverting input terminal which receives a reference voltage;
a fifth resistor, wherein the other one of the first analog audio signal and the second analog audio signal is received at one terminal of the fifth resistor, and the other terminal of the fifth resistor is connected to an inverting input terminal of the second operational amplifier;
a sixth resistor, wherein the third analog audio signal is received at one terminal of the sixth resistor, and the other terminal of the sixth resistor is connected to the inverting input terminal of the second operational amplifier; and
a seventh resistor disposed between an output terminal and the inverting input terminal of the second operational amplifier.

8. The mixer circuit of claim 7, wherein the inverting amplifier comprises:
a third operational amplifier including a non-inverting input terminal which receives the reference voltage;
an eighth resistor, wherein the one of the first analog audio signal and the second analog audio signal is received at one terminal of the eighth resistor, and the other terminal of the eighth resistor is connected to an inverting input terminal of the third operational amplifier; and
a ninth resistor disposed between an output terminal and the inverting input terminal of the third operational amplifier.

9. A mixer circuit for mixing two audio signals, the mixer circuit comprising:
a first D/A converter configured to convert a first digital audio signal to a first analog audio signal;
a second D/A converter configured to convert a second digital audio signal to a second analog audio signal; and
an output stage configured to add the first analog audio signal and the second analog audio signal or subtract one of the first analog audio signal and the second analog audio signal from the other one of the first analog audio signal and the second analog audio signal,
wherein a first noise component is superimposed on the first analog audio signal in the first D/A converter, and a second noise component is superimposed on the second analog audio signal in the second D/A converter, and the second noise component is in phase with the first noise component, and
wherein the mixer circuit is configured such that (i) the first analog audio signal and the second analog audio signal included in an output signal of the output stage have the same polarity, and (ii) the first noise component and the second noise component included in the output signal of the output stage have opposite polarities.

10. An audio signal processing circuit comprising: the mixer circuit of claim 1.

11. The audio signal processing circuit of claim 10, further comprising:
a digital signal processor configured to perform digital signal processing on each of a plurality of input digital audio signals, and output the processed plurality of digital audio signals as the first digital audio signal and the second digital audio signal to the mixer circuit.

12. The audio signal processing circuit of claim 10, further comprising:
a first analog volume circuit disposed at a succeeding stage of the first D/A converter of the mixer circuit, the first analog volume circuit is configured to amplify the first analog audio signal by a gain according to a volume setting value; and
a second analog volume circuit disposed at a succeeding stage of the second D/A converter of the mixer circuit, the second analog volume circuit is configured to amplify the second analog audio signal by the gain according to the volume setting value.

13. The audio signal processing circuit of claim 10, wherein the audio signal processing circuit is integrated in a single semiconductor substrate.

14. An audio device for a vehicle comprising: the audio signal processing circuit of claim 10.

15. An electronic device comprising: the audio signal processing circuit of claim 10.

16. An audio component device comprising: the audio signal processing circuit of claim 10.

17. A method for mixing two audio signals, the method comprising:
converting, by a first D/A converter, a first digital audio signal to a first analog audio signal;
inverting a polarity of a second digital audio signal to generate a third digital audio signal;
converting, by a second D/A converter, the third digital audio signal to a second analog audio signal; and
adding the first analog audio signal and the second analog audio signal by changing a polarity of one of the first analog audio signal and the second analog audio signal.

18. The method of claim 17, wherein the adding the first analog audio signal and the second analog audio signal comprises: subtracting one of the first analog audio signal and the second analog audio signal from the other one of the first analog audio signal and the second analog audio signal.

19. The method of claim 17, wherein the adding the first analog audio signal and the second analog audio signal comprises:
inverting one of the first analog audio signal and the second analog audio signal to generate a third analog audio signal; and
adding the other one of the first analog audio signal and the second analog audio signal and the third analog audio signal.
